(19) United States
(12) Patent Application Publication
(10) Pub. No.: US 2006/0078846 A1
(43) Pub. Date: Apr. 13, 2006

(54) Toothferri finder

(76) Inventors: Lawrence Ferri, Cement City, MI (US); Lori Elizabeth Stump, Clark lake, MI (US)

Correspondence Address: Lawrence Ferri, 10901 Briggs Hwy, Cement City, MI, 49233, US

(21) Appl. No.: 10/831,624

(22) Filed: Oct. 12, 2004

(51) Int. Cl. A61C 13/00

(52) U.S. Cl. 433/167

(57) ABSTRACT

A device that will accommodate one to find their lost dentures using a radio frequency transponder. The invention consists of one radio frequency transponder that will emit a loud beeping sound that will become faster the closer you are to the lost dentures and a small light that will flash faster the closer you are to the lost dentures. This will accommodate both the seeing and hearing impaired denture wearers. The invention will also contain two encapsulated transmitters that are able to be embedded in the top and bottom molar of the dentures. The invention is intended for all denture wearers for private use in either their home or in a care facility.

The device is to help people find their misplaced dentures. There are two small electronic device's one will be inserted into the top set of dentures and then another in the bottom set of dentures. This device will be very small and a hole will be drilled in the denture's molar, then filled back in with a dental filling. The other part of the invention is a small transmitter, that is the size of a garage door opener. This part can be in a sleeve that is mountable, or on a key chain.

If the teeth are lost, the device can be used to find them. When the button is pushed it will send a signal out to the device in the dentures and then the signal will in turn be received by the transmitter/receiver device with either a blinking light that blinks faster the closer you get to the device or a beeping noise that will get louder and beep faster once you are closer to the dentures. The blinking light will accommodate the hard of hearing and the beeping sound will accommodate the seeing impaired.

The device that is inserted into the dentures will have to be made of a non-toxic material, shock absorbent material and water resistant material.

I claim:

1. A device for personal home use for locating a lost denture using a RF passive transponder using a small portable transceiver for emitting a signal with a beeping noise that intensifies the closer you are to the lost denture and also the transceiver has a small light that will also blink faster the closer you are to the lost denture. The beeping noise is intended to aid the seeing impaired and the blinking light is intended to aid the hearing impaired.

2. The device of claim 1 wherein the transponder is encapsulated in the top and bottom molar of the dentures.

3. The device of claim 1 wherein is a transceiver that will be portable and there will be two transponders, one for the top denture and one for the bottom denture. This devise will be available for the entire public.

4. A-set of dentures that can be located and identified when lost, comprising,
A radio frequency transponder embedded within the molar of the dentures, and a portable transmitter that will emit a beeping noise the closer you are from the lost dentures and the transmitter will have a small light that will blink faster the closer you are from the lost dentures.
